(19) United States
(12) Patent Application Publication
(10) Pub. No.: US 2025/0293762 A1
(43) Pub. Date: Sep. 18, 2025

(54) WIRELESS COMMUNICATION METHOD AND WIRELESS COMMUNICATION SYSTEM

(71) Applicant: NIPPON TELEGRAPH AND TELEPHONE CORPORATION, Tokyo (JP)

(72) Inventors: Koichi HARADA, Musashino-shi, Tokyo (JP); Junichi ABE, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/860,701

(22) PCT Filed: May 11, 2022
(86) PCT No.: PCT/JP2022/019929

§ 371 Date: Oct. 28, 2024

(51) Int. Cl. H04B 7/185; H04W 40/12; H04W 84/06

(52) U.S. Cl. CPC H04B 7/18506; H04B 7/18513; H04W 40/12; H04W 84/06

(57) ABSTRACT

A wireless communication method according to an embodiment extracts rainfall data of each of places between a plurality of relay stations moving in the sky in an NTN and a plurality of ground stations placed on the ground in respective cells formed by the relay stations at predetermined time intervals from rainfall prediction of each predetermined region based on observation data of a weather radar, predicts deterioration in communication of a feeder link of each of the plurality of relay stations caused by rainfall on the basis of the extracted rainfall data, determines a communication quality of the feeder link of each of the plurality of relay stations on the basis of the predicted deterioration in communication of each feeder link, and controls the feeder link such that the feeder link satisfies a predetermined communication quality.

### TECHNICAL FIELD

The present invention relates to a wireless communication method and a wireless communication system.

### BACKGROUND ART

A mobile communication system has developed in recent years, and mobile services can be received on most of the ground. Further, super coverage is one of requirements for a fifth generation (Beyond 5G) or sixth generation mobile communication system expected to be commercialized in the future.

Super coverage means expanding a service area to a place where it is expensive to install an existing base station, such as a mountain, sea, or air, or to a place where it is difficult to install a base station. Further, national resilience against natural disasters and the like is also required, and appearance of a communication system resilient against disasters on the ground is desired.

In order to achieve such a wireless communication system, a non-terrestrial network (NTN) using a geostationary satellite (GEO: geostationary orbit), a medium earth orbit satellite (MEO: medium earth orbit), a low earth orbit satellite (LEO: low earth orbit), a high altitude platform station (HAPS), an unmanned aerial vehicle (UAV), a drone, and the like has attracted attention (see, for example, Non Patent Literature 1).

In the NTN, the above satellites, HAPS, and the like connect communication links to each other to form a network and are further connected to a mobile network on the ground via a ground base station. The satellites and HAPS have a relay communication function.

A communication line in the HAPS includes a feeder link (FL) between the HAPS and a ground gateway station (ground station) in a ground communication network and a service link (SL) between a communication relay device and a terminal. For example, the HAPS is located at an altitude of approximately 20 km, and a radius of a ground area (cell) is approximately 50 km. In the service link of the HAPS, use of frequencies of 2 GHz is assumed, but, in the feeder link, use of millimeter waves in a higher frequency band (e.g., 38 GHz band) has been examined.

Traffic packets transmitted by the terminal are transferred to the HAPS connected to the ground station by a routing function and are transmitted to the Internet network. Packets transmitted from the Internet network to another terminal are also subjected to similar processing by the routing function.

In the NTN, radio waves in a high frequency band are used, and deterioration in wireless communication quality caused by an influence of rainfall is assumed. For example, in a case where there is the influence of rainfall, a service may be disconnected due to rainfall in the FL (feeder link) of the NTN using the high frequency band.

In order to prevent the disconnection of the feeder link, for example, there has been examined a method of, in an area (cell) covered by one HAPS, switching a feeder link in the area by using rainfall prediction (see, for example, Non Patent Literature 2).

Regarding a frequency (GHz) characteristic of rain attenuation (dB/km), CCIR Rep. 721-3 FIG. 1 discloses the characteristic for each 1-hour rainfall intensity (mm/h) (see, for example, Non Patent Literature 3).

Regarding a slant path between the HAPS and the ground station, ITU-R P618-13 FIG. 1 discloses a concept of a length of a rainfall propagation path and an angle of elevation (see, for example, Non Patent Literature 4).

Regarding the rainfall prediction, precipitation intensity prediction per 250-m mesh throughout Japan (every 5 minutes until 60 minutes later) can be performed based on data of High-resolution Precipitation Nowcasts provided by Japan Meteorological Agency (see, for example, Non Patent Literature 5).

### CITATION LIST

### Patent Literature

Patent Literature 1: US 2016/0,046,387 A

### Non Patent Literature

Non Patent Literature 1: Yamashita, “R&D on IOWN Space Sensing and/or Radio Access Networks”, SAT2021-29.
Non Patent Literature 2: Kitanozono, Suzuki, Kishiyama, Hokazono, Sotoyama, Ouchi, Miura, and Tsuji, “Development of HAPS Backhaul System using mmWave Frequency-HAPS as a NTN System for 5G and Beyond-”, SAT2021-30.
Non Patent Literature 3: CCIR Rep. 721-3 Attenuation by Hydrometeors, in Particular Precipitation, and Other Atmospheric Particles (frequency (GHz) characteristics of rain attenuation (dB/km))
Non Patent Literature 4: ITU-R P618-13 Propagation data and prediction methods required for the design of Earth-space telecommunication systems (propagation path between earth station and satellite)
Non Patent Literature 5: Japan Meteorological Agency, High-resolution Precipitation Nowcasts https://www.jma.go.jp/jma/kishou/know/kurashi/highres_nowcast.html

### SUMMARY OF INVENTION

### Technical Problem

However, conventionally, in a case where an entire service area (cell) is affected by rainfall, a service may be disconnected due to the rainfall in an FL of an NTN using a high frequency band.

The present invention has been made in view of the above problems, and an object thereof is to provide a wireless communication method and a wireless communication system capable of preventing deterioration in communication quality even in a case where the entire area covered by one relay station moving in the sky in the NTN is affected by rainfall.

### Solution to Problem

A wireless communication method according to an embodiment of the present invention is a wireless communication method with an NTN, the wireless communication method including: an extraction step of extracting rainfall data of each of places between a plurality of relay stations moving in the sky in the NTN and a plurality of ground stations placed on the ground in respective cells formed by the relay stations at predetermined time intervals from rainfall prediction of each predetermined region based on observation data of a weather radar; a prediction step of predicting deterioration in communication of a feeder link of each of the plurality of relay stations caused by rainfall on the basis of the extracted rainfall data; a determination step of determining whether or not the feeder link of each of the plurality of relay stations satisfies a predetermined communication quality on the basis of the predicted deterioration in communication of each feeder link; and a control step of, in a case where it is determined that the feeder link of the relay station to which a service link is connected does not satisfy the predetermined communication quality, controlling the feeder link such that the feeder link satisfies the predetermined communication quality.

A wireless communication system according to one embodiment of the present invention is a wireless communication system including an NTN, the wireless communication system including: an extraction unit that extracts rainfall data of each of places between a plurality of relay stations moving in the sky in the NTN and a plurality of ground stations placed on the ground in respective cells formed by the relay stations at predetermined time intervals from rainfall prediction of each predetermined region based on observation data of a weather radar; a prediction unit that predicts deterioration in communication of a feeder link of each of the plurality of relay stations caused by rainfall on the basis of the rainfall data extracted by the extraction unit; a determination unit that determines whether or not the feeder link of each of the plurality of relay stations satisfies a predetermined communication quality on the basis of the deterioration in communication of each feeder link predicted by the prediction unit; and a control unit that, in a case where the determination unit determines that the feeder link of the relay station to which a service link is connected does not satisfy the predetermined communication quality, controls the feeder link such that the feeder link satisfies the predetermined communication quality.

### Advantageous Effects of Invention

The present invention can prevent deterioration in communication quality even in a case where the entire area covered by one relay station moving in the sky in an NIN is affected by rainfall.

### BRIEF DESCRIPTION OF DRAWINGS

FIG. 1(a) illustrates a configuration example of a wireless communication system including a cell formed by one relay station moving in the sky. FIG. 1(b) illustrates a configuration example of a wireless communication system including cells formed by two relay stations moving in the sky.

FIG. 2 is a functional block diagram showing functions of a wireless communication system according to an embodiment.

FIG. 3 illustrates a wireless communication system in which cells C2 to C9 are placed around a cell C1.

FIG. 4 illustrates a case where a rain cloud covers a range of a plurality of cells in the wireless communication system of FIG. 3.

FIG. 5 shows a relationship among a ground station, a relay station, and a rain cloud in the wireless communication system according to the embodiment.

FIG. 6 shows a relationship among an altitude to be considered, an area, and the number of meshes.

FIG. 7 is a flowchart showing an overall processing example of the wireless communication system.

FIG. 8 is a flowchart showing details of processing of acquiring an FL frequency, a 1 h rainfall intensity, and an amount of attenuation.

FIG. 9 is a flowchart showing details of processing of acquiring latitude and longitude of a ground station in each cell.

FIG. 10 is a flowchart showing details of processing of extracting rainfall intensity data of each cell.

FIG. 11 is a flowchart showing details of processing of extracting predicted values of rainfall intensity data of each cell.

FIG. 12 is a flowchart showing details of processing of examining cell switching.

FIG. 13 is a flowchart showing details of processing of examining a cell switching destination.

FIG. 14 shows a relationship between a rainfall intensity (mm/h) and an amount of attenuation (dB).

FIG. 15 shows a relationship between a rainfall intensity (mm/h) and an amount of attenuation (dB) for each frequency.

FIG. 16 shows an example of predicted values of a rainfall intensity of High-resolution Precipitation Nowcasts at a cell C1.

FIG. 17 shows an example of predicted values of a rainfall intensity of High-resolution Precipitation Nowcasts at a cell C2.

FIG. 18 shows an example of predicted values of a rainfall intensity of High-resolution Precipitation Nowcasts at a cell C3.

FIG. 19 shows an example of predicted values of a rainfall intensity of High-resolution Precipitation Nowcasts at a cell C4.

FIG. 20 shows predicted values of a rainfall intensity and an actual rainfall section.

FIG. 21 schematically shows a state of converting a rainfall intensity into an amount of rain attenuation.

### DESCRIPTION OF EMBODIMENTS

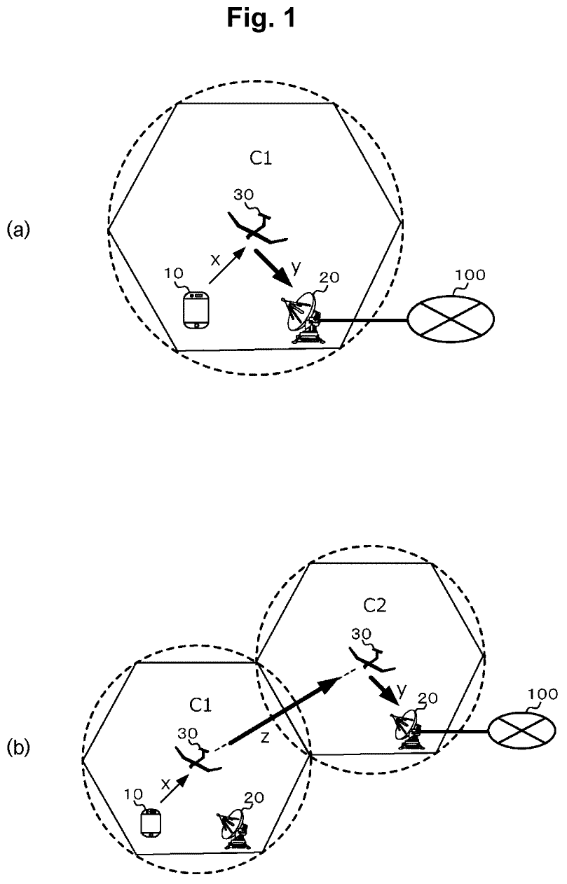

Hereinafter, a wireless communication system according to an embodiment will be described with reference to the drawings. FIG. 1 illustrates a configuration example of a wireless communication system including an NTN according to the embodiment. FIG. 1(a) illustrates a configuration example of the wireless communication system including a cell formed by one relay station moving in the sky. FIG. 1(b) illustrates a configuration example of the wireless communication system including cells formed by two relay stations moving in the sky. Note that the number of cells of the wireless communication system according to the embodiment is not limited.

As illustrated in FIG. 1(a), in the wireless communication system including the NTN, a terminal 10 and a ground station 20 perform wireless communication via a relay station 30 moving in the sky, such as a HAPS. The relay station 30 forms an area (cell C1) covering wireless communication. The relay station 30 may also be a low earth orbit (LEO) satellite or the like.

The ground station 20 is placed on the ground and is connected to another base station, another terminal 10, a control station, and the like (not shown) via a network 100.

The terminal 10 transmits a signal to the relay station 30 via, for example, a service link of an S-band radio wave. The relay station 30 transmits a signal to the ground station 20 via, for example, a feeder link of a Q/V-band radio wave.

As illustrated in FIG. 1(b), the wireless communication system including the NTN can establish a connection to transmit a signal from the relay station 30 forming the cell C1 to the relay station 30 forming an adjacent cell C2 by using, for example, a Q/V-band radio wave.

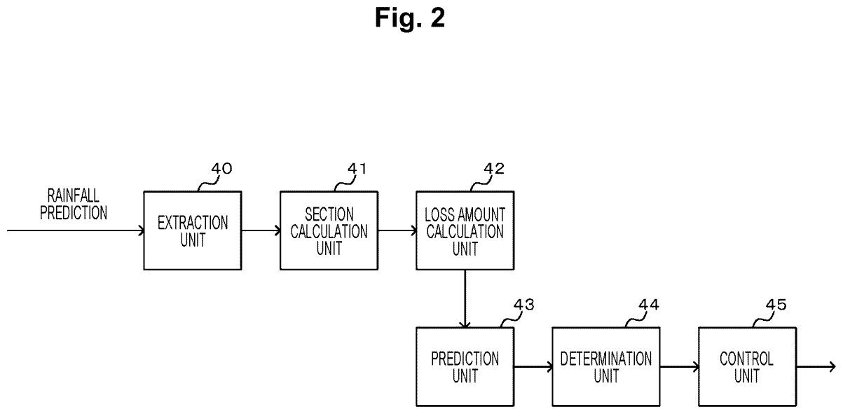

FIG. 2 is a functional block diagram showing functions of the wireless communication system according to the embodiment. Any of the terminal 10, the ground station 20, the relay station 30, a control station (not shown), and the like may have all or some of the functions shown in FIG. 2.

As shown in FIG. 2, the wireless communication system includes an extraction unit 40, a section calculation unit 41, a loss amount calculation unit 42, a prediction unit 43, a determination unit 44, and a control unit 45.

The extraction unit 40 extracts rainfall data of each of places between a plurality of relay stations 30 and a plurality of ground stations 20 in respective cells formed by the relay stations 30 at predetermined time intervals from rainfall prediction of each predetermined region based on observation data of a weather radar, for example, and outputs the extracted rainfall data to the section calculation unit 41. For example, the extraction unit 40 acquires rainfall prediction of High-resolution Precipitation Nowcasts or the like and extracts rainfall data at predetermined time intervals.

High-resolution Precipitation Nowcasts provides mesh data of rainfall predicted and analyzed by a supercomputer on the basis of international rules (GRIB format). For example, High-resolution Precipitation Nowcasts predicts detailed analysis and movement, development, and decline of rain clouds, generation of a new rain cloud, and the like. At this time, for example, an analysis time is set to every 5 minutes, a grid interval is set to 250 m, a prediction time/time resolution is set to every 1 hour/5 minutes, a predicted grid interval is set to 250 m up to 30 minutes and 1 km from 35 to 60 minutes.

The section calculation unit 41 calculates each rainfall section between the relay station 30 and the ground station 20 on the basis of the rainfall data extracted by the extraction unit 40 and outputs the rainfall section to the loss amount calculation unit 42.

The loss amount calculation unit 42 calculates an amount of radio wave propagation loss caused by each rainfall section calculated by the section calculation unit 41 and outputs the amount of radio wave propagation loss to the prediction unit 43.

The prediction unit 43 predicts deterioration in communication of the feeder link of each of the plurality of relay stations 30 caused by rainfall on the basis of each amount of radio wave propagation loss calculated by the loss amount calculation unit 42 and outputs the prediction result to the determination unit 44.

The determination unit 44 determines whether or not the feeder link of each of the plurality of relay stations 30 satisfies a predetermined communication quality on the basis of the deterioration in communication of each feeder link predicted by the prediction unit 43 and outputs the determination result to the control unit 45.

In a case where the determination unit 44 determines that the feeder link of the relay station 30 to which the service link is connected does not satisfy the predetermined communication quality, the control unit 45 controls the feeder link such that the feeder link satisfies the predetermined communication quality.

For example, in a case where the determination unit 44 determines that the feeder link of the relay station 30 to which the service link is connected does not satisfy the predetermined communication quality, the control unit 45 performs control to switch a propagation path such that any of other relay stations 30 whose feeder links are determined by the determination unit 44 to satisfy the predetermined communication quality relays the feeder link of the relay station 30 to any of the ground stations 20.

In a case where the determination unit 44 determines that the feeder link of the relay station 30 to which the service link is connected does not satisfy the predetermined communication quality, the control unit 45 may perform control to increase transmission power of the relay station 30 or to change a modulation method or code rate of the relay station 30.

The wireless communication system according to the embodiment extracts rainfall intensity data in a direction from the ground station of the NTN to the NTN by using the rainfall data of High-resolution Precipitation Nowcasts, predicts deterioration in communication caused by rainfall on the basis of a current value and predicted values of the rainfall data, compares communication quality in a cell with data of another cell, and examines and determines whether to switch a propagation path to a cell not affected by rainfall.

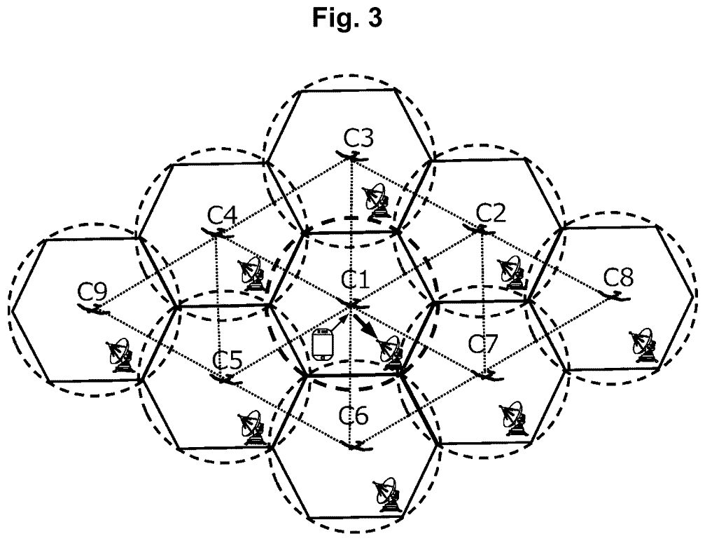

Next, a specific operation example of the wireless communication system according to the embodiment will be described. FIG. 3 illustrates the wireless communication system in which cells C2 to C9 are placed around the cell C1. A plurality of relay stations 30 forming the cells C1 to C9 can be connected to other relay stations 30 forming adjacent cells. Each cell has a configuration similar to the configuration of FIG. 1.

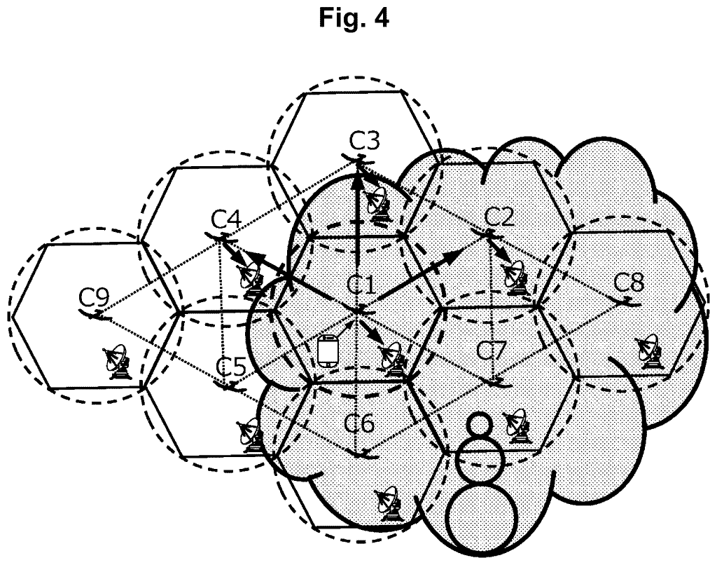

FIG. 4 illustrates a case where a rain cloud covers a range of a plurality of cells in the wireless communication system of FIG. 3. Wireless communication may be affected in the cells covered by the rain cloud as described later.

In the example of FIG. 4, in a state in which the plurality of cells is affected by rainfall and the cell C1 cannot connected (FL) to the ground station 20, the cells C2 and C3 are similarly affected by rainfall and thus cannot be connected to the ground station 20. However, the cell C4 is less affected by rainfall and thus can be connected to the ground station 20. In order to connect the cell C1 to the ground station 20, it is possible to connect and maintain communication in the cell C1 by connecting the cell C1 to the ground station 20 of the cell C4 by using communication between the relay stations 30.

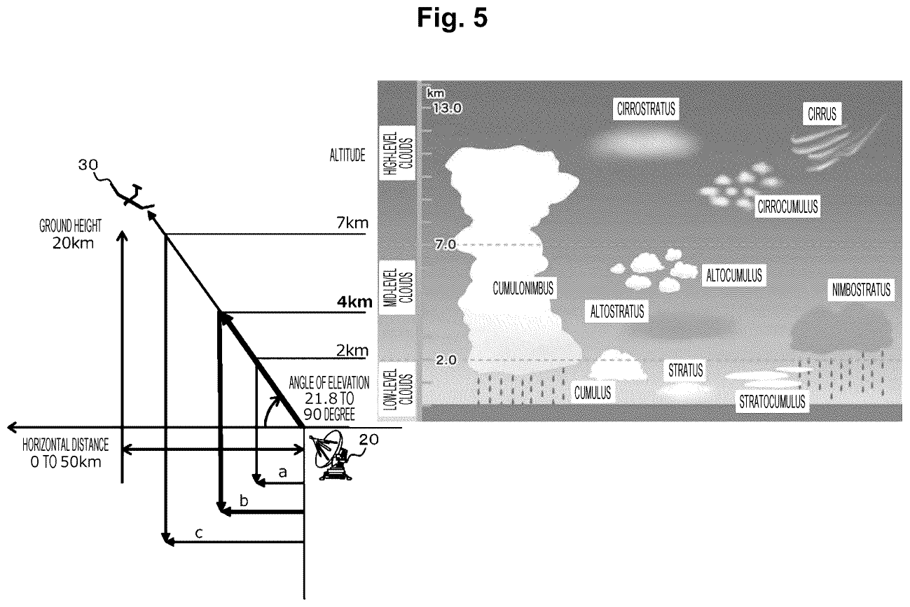

FIG. 5 shows a relationship among the ground station 20, the relay station 30, and a rain cloud in the wireless communication system according to the embodiment. FIG. 5 shows an altitude at which raindrops are present and assumed horizontal distances of a rain radar.

In order to maintain connection without disconnecting a communication service of the cell C1, it is necessary to select a switching destination cell by predicting an influence of rainfall. The wireless communication system can select a connection destination cell on the basis of rainfall prediction by using data of High-resolution Precipitation Nowcasts acquired from the rain radar. Note that, because High-resolution Precipitation Nowcasts has only data in a horizontal direction, a case of only the horizontal direction will be described.

Regarding the influence of rainfall, an influence of raindrops is actually large, and an influence of rain clouds is small. Thus, the altitude to be considered here is assumed to be 4 km. For example, the relay station 30 such as the HAPS stays at the altitude of 20 km and has an area having a radius of approximately 50 km, and thus the angle of elevation of the relay station 30 viewed from the ground station 20 is approximately 90 degrees at the center of the area and approximately 21.8 degrees at the end of the area.

For example, when the angle of elevation is 45 degrees, the horizontal distance affected by raindrops is 4 km, which is the same as the altitude, as shown in Equations (1) and (2) below. High-resolution Precipitation Nowcasts provides 250-m mesh rainfall data, and thus rainfall data of 16 meshes corresponds to 4 km.

$$[ Math . 1 ]$$

$$Propagation distance at altitude of \\ 4 km and angle of elevation of 45 degrees$$

$$= 4 / [ {\{ sin ( 45 ° ) \}}^{′} ] = 4 \times \sqrt{2} = 5.66 \qquad ( 1 )$$

$$[ Math . 2 ]$$

$$4 km / tan ( 45 ° ) = 4 km \qquad ( 2 )$$

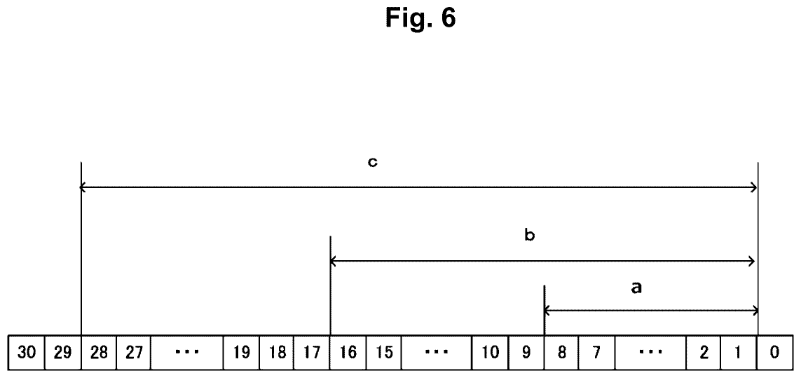

FIG. 6 shows a relationship among the altitude to be considered, the area, and the number of meshes. As described above, in a case where the altitude to be considered is 2 km, 2 km/tan (45°)=2 km holds, and the number of 250-m meshes is 8 (a). In a case where the altitude to be considered is 4 km, 4 km/tan (45°)=4 km holds, and the number of 250-m meshes is 16 (b). In a case where the altitude to be considered is 7 km, 7 km/tan (45°)=7 km holds, and the number of 250-m meshes is 28 (c).

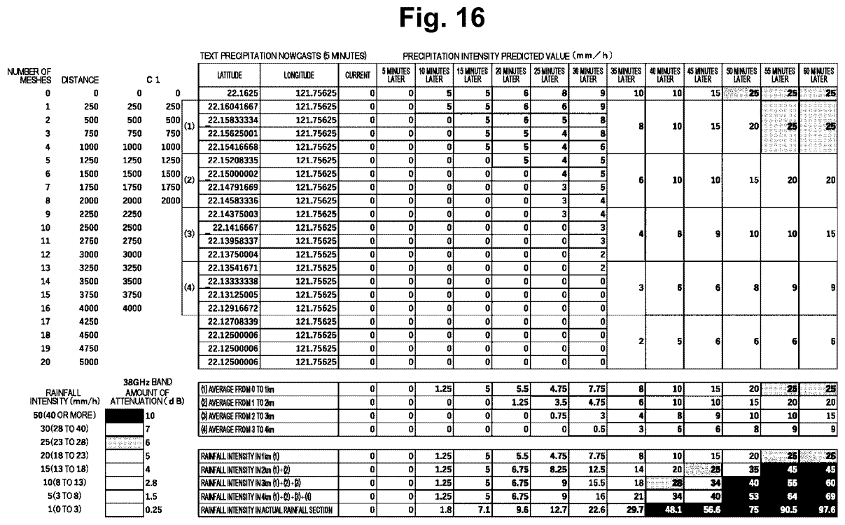

The data of High-resolution Precipitation Nowcasts is a GRIB2 format file, but necessary information can be extracted as a CSV file. Here, based on positions (latitude and longitude) of the ground stations 20 in the switching source cell C1 and the switching destination cells C2 to C4, rainfall intensity data for every 5 minutes from current values of the target 16 meshes until 60 minutes later is extracted in a direction of the relay station 30 in each cell (see FIGS. 16 to 19).

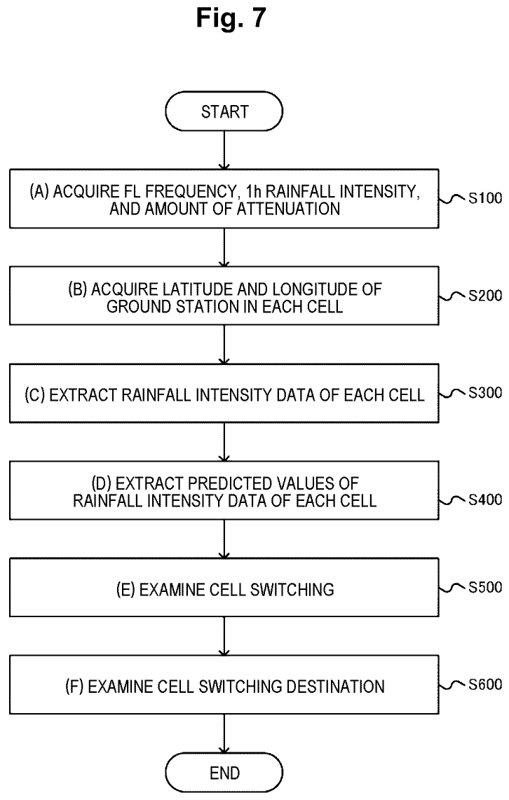

Then, the wireless communication system predicts rain attenuation on the basis of the rainfall intensity data, selects the ground station 20 in a cell not affected by rainfall, and maintains communication, thereby achieving improvement in an operation rate (see FIGS. 7 to 13).

FIG. 7 is a flowchart showing an overall processing example of the wireless communication system. As shown in FIG. 7, the wireless communication system (A) acquires an FL frequency, a 1 h rainfall intensity, and an amount of attenuation (S100) and (B) acquires the latitude and longitude of the ground station in each cell (S200) as setting of initial parameters.

Next, the wireless communication system (C) extracts rainfall intensity data of each cell (S300) and (D) extracts predicted values of the rainfall intensity data of each cell (S400).

Then, the wireless communication system (E) examines cell switching (S500) and (F) examines a cell switching destination (S600).

Next, the above processing (A) to (F) performed by the wireless communication system will be described in more detail.

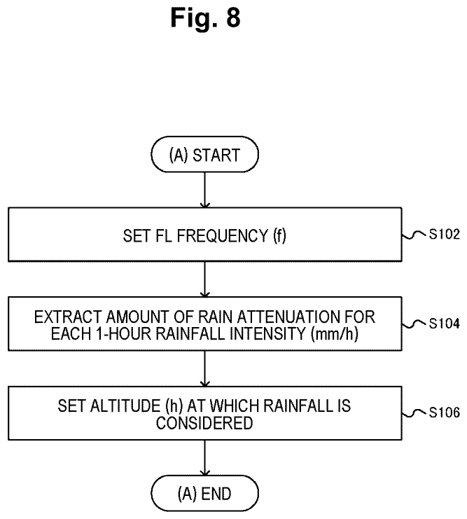

FIG. 8 is a flowchart showing details of the processing of (A) acquiring the FL frequency, the 1 h rainfall intensity, and the amount of attenuation. First, the wireless communication system sets, for example, 38 GHz (f=38) as the FL frequency (f) (S102).

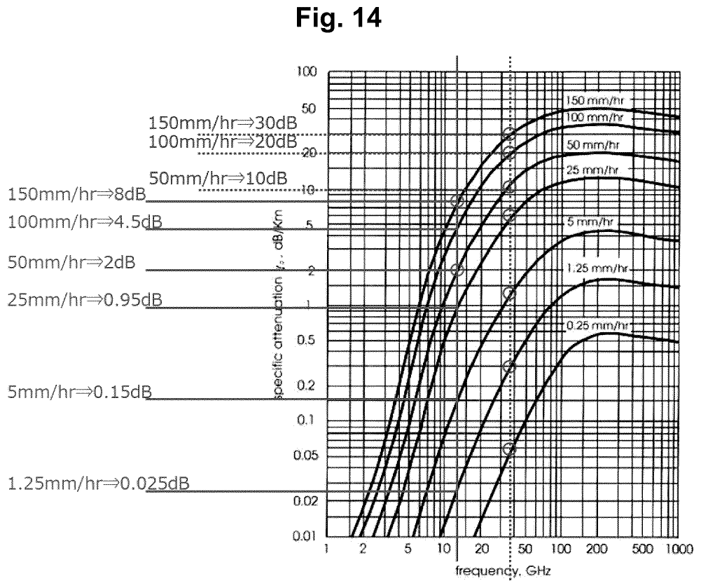

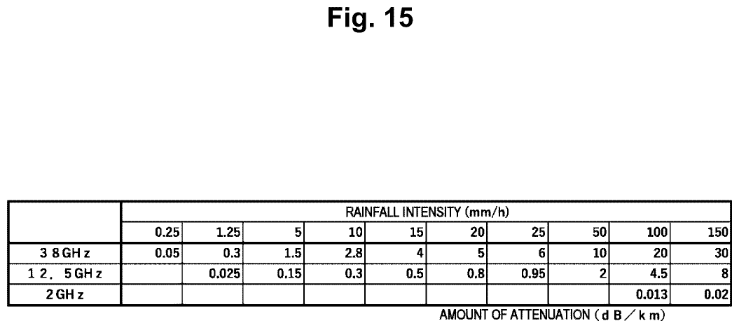

Next, the wireless communication system extracts the rain attenuation (dB/km) for each 1-hour rainfall intensity (mm/h) at the set frequency (f) on the basis of the frequency (GHz) characteristic of the rain attenuation (dB/km) of CCIR Rep. 721-3 shown in FIG. 14 (S104). Here, amounts of rain attenuation extracted at f=38 GHz, 12.5 GHz, and 2 GHz are shown in FIG. 15.

The 1-hour rainfall intensity is shown per 250-m mesh, and thus, if the 1-hour rainfall intensity continues for 1 km (four meshes), the amount of attenuation of ITU-R can be applied.

For example, if rain of 5 mm/h continues for 1 km in a 38 GHz band, a signal attenuates by 1.5 dB. For example, if rain of 25 mm/h continues for 1 km in the 38 GHz band, a signal attenuates by 6 dB.

Then, the wireless communication system sets the altitude (h) at which rainfall is considered (S106). For example, 4 km (h=4) is set, and the processing of (A) acquiring the FL frequency, the 1-hour rainfall intensity, and the amount of attenuation ends.

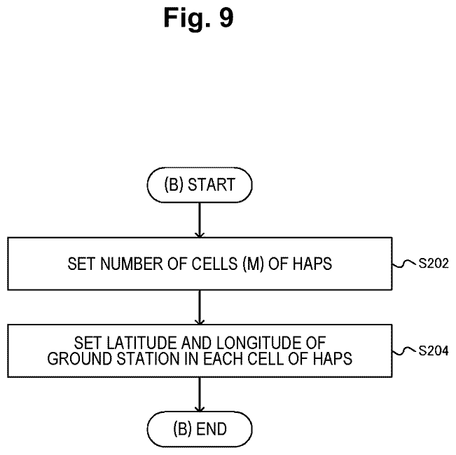

FIG. 9 is a flowchart showing details of the processing of (B) acquiring the latitude and longitude of the ground station in each cell. First, the wireless communication system sets the number of cells (M) of the relay stations 30 to 4 (M=4) (S202). Next, the wireless communication system sets the latitude and longitude of the ground station 20 in each cell of the relay station 30 (S204).

For example, the wireless communication system sets the cell C1: (22.1625, 121.75625), the cell C2: (22.15833, 122.8813), the cell C3: (22.15625, 124.0063), and the cell C4: (22.15417, 125.1313), and ends the processing of (B) acquiring the latitude and longitude of the ground station in each cell.

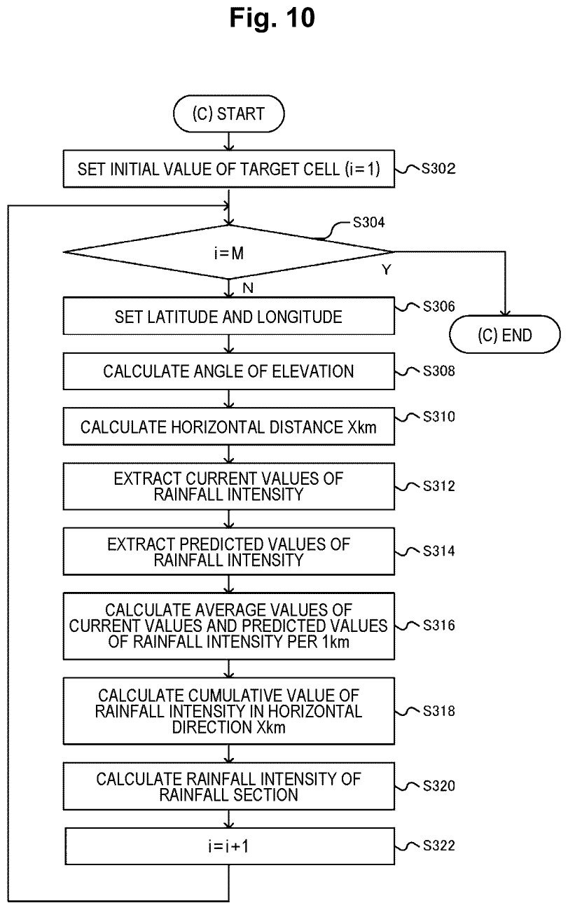

FIG. 10 is a flowchart showing details of the processing of (C) extracting the rainfall intensity data of each cell. First, the wireless communication system initializes a cell number (i) of a target cell (Ci) and sets an initial value to i=1 (S302).

Next, the wireless communication system determines whether or not the target cell (i) is a final cell (M) (S304). When i=M is satisfied (S304: Yes), the processing of (C) extracting the rainfall intensity data of each cell ends. When i=M is not satisfied (S304: No), the processing proceeds to S306. Hereinafter, the cell C1 will be described as an example.

In the processing in S306, the wireless communication system sets the latitude and longitude of the ground station 20 in the target cell to (22.1625, 121.75625), for example, in the case of the C1 cell.

In the processing in S308, the wireless communication system calculates the angle of elevation (El) of the relay station 30 viewed from the ground station 20 as, for example, 45 degrees (El=45).

In the processing in S310, the wireless communication system calculates a horizontal distance X km in a direction from the ground station 20 toward the relay station 30 by X=h/tan (El) (S310). For example, X=4/tan (45 degrees)=4 (km) is set.

Thereafter, the wireless communication system extracts a rainfall intensity of 250-m mesh data from High-resolution Precipitation Nowcasts. For example, the wireless communication system sets X=4 km, and description will be made below with reference to FIG. 16.

FIG. 16 shows an example of predicted values of the rainfall intensity of High-resolution Precipitation Nowcasts (5 minutes) at the cell C1. For example, attenuation of 5 dB/km in the 38 GHz band occurs at the rainfall intensity of approximately 20 mm/h. Therefore, the attenuation occurs in 50 minutes in a case of 1 km, and thus the wireless communication system determines that it is necessary to switch to another relay station 30 therebefore.

In a case of 2 km, the attenuation occurs in 40 minutes, and, in a case of 3 km, the attenuation occurs in 35 minutes, and, even in a case of 4 km, the attenuation occurs in 30 minutes in the above example.

As shown in FIG. 16, the wireless communication system extracts current values of the rainfall intensity (mm/h) for the horizontal distance X km (S312) and extracts predicted values of the rainfall intensity for every 5 minutes until 60 minutes later (S314).

In the processing in S316, the wireless communication system calculates averages of the current values and the predicted values of the rainfall intensity (250-m mesh×4) per 1 km in the horizontal direction.

In the processing in S318, the wireless communication system calculates the rainfall intensity per 1 km and calculates a cumulative value of the rainfall intensity. In FIG. 16, 0 to 1 km is shown in (1), up to 2 km is shown in (2), and subsequent distances are shown in (3) and (4). Here, the wireless communication system calculates a cumulative value of the rainfall intensity in the horizontal distance Xkm. In FIG. 16, the cumulative value is shown in “(1)+(2)+(3)+(4) equivalent to 4 km”.

In the processing in S320, the wireless communication system calculates the rainfall intensity of the rainfall section. The rainfall section on an actual propagation path is (sin(El))⁻¹ times larger than the horizontal distance Xkm by using the angle of elevation El. In a case where the angle of elevation is El=45 degrees, the rainfall section is √2 times (see FIG. 16).

Then, the wireless communication system sets i=i+1 and returns to the processing in S304 to transition to the next target cell (S322).

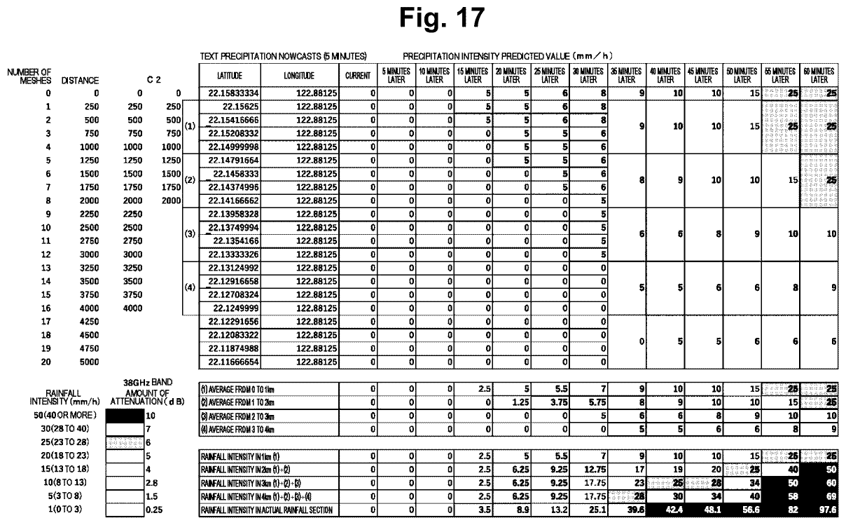

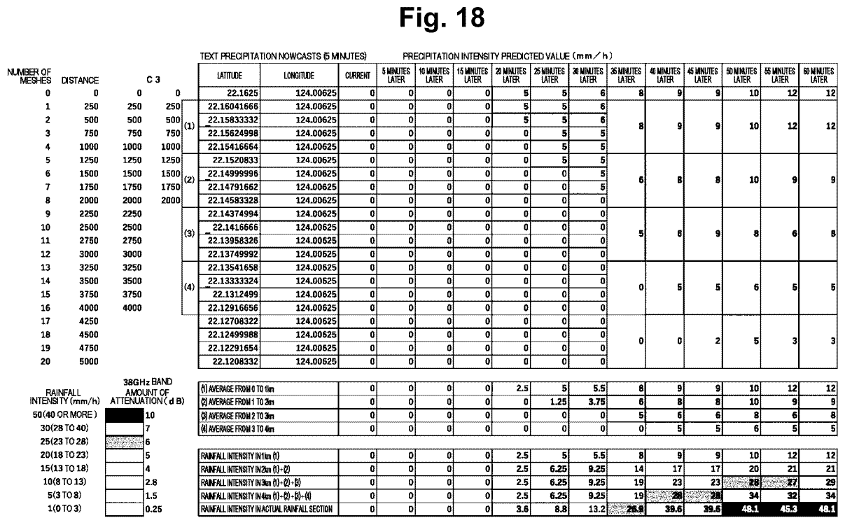

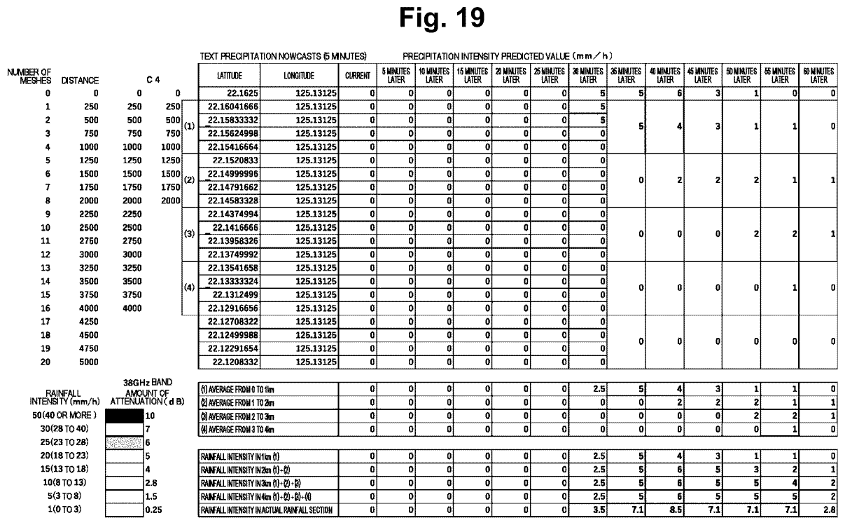

As in FIG. 16, FIG. 17 shows data extracted for the cell C2, FIG. 18 shows data extracted for the cell C3, and FIG. 19 shows data extracted for the cell C4.

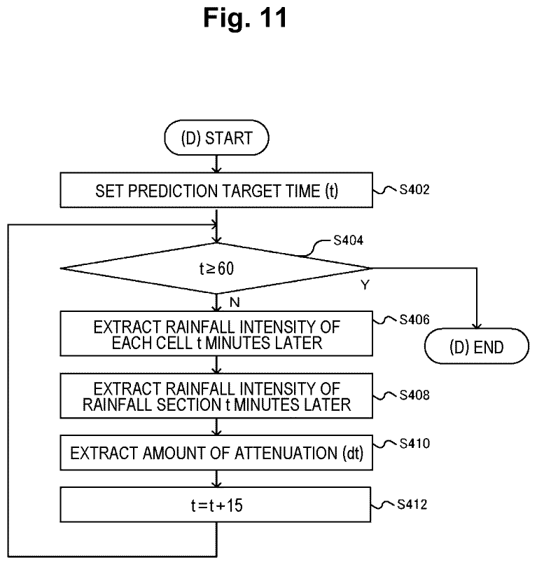

FIG. 11 is a flowchart showing details of the processing of (D) extracting the predicted values of the rainfall intensity data of each cell. First, the wireless communication system sets a prediction target time (t) to, for example, 30 minutes (t=30) (S402).

In the processing in S404, the wireless communication system determines whether or not the prediction target time (t) is equal to or longer than a prediction target final time (60 minutes). When the prediction target time (t) is equal to or longer than the prediction target final time (S404: Yes), the wireless communication system ends the processing of (D) extracting the predicted values of the rainfall intensity data of each cell. When the prediction target time (t) is not equal to or longer than the prediction target final time (S404: No), the processing proceeds to the processing in S406. Hereinafter, description will be made by setting the prediction target time to 30 minutes.

In the processing in S406, the wireless communication system extracts the rainfall intensity of each cell t minutes later.

In the processing in S408, the wireless communication system extracts the rainfall intensity in the horizontal distance X km per 250-m mesh and per 1 km and the actual rainfall section.

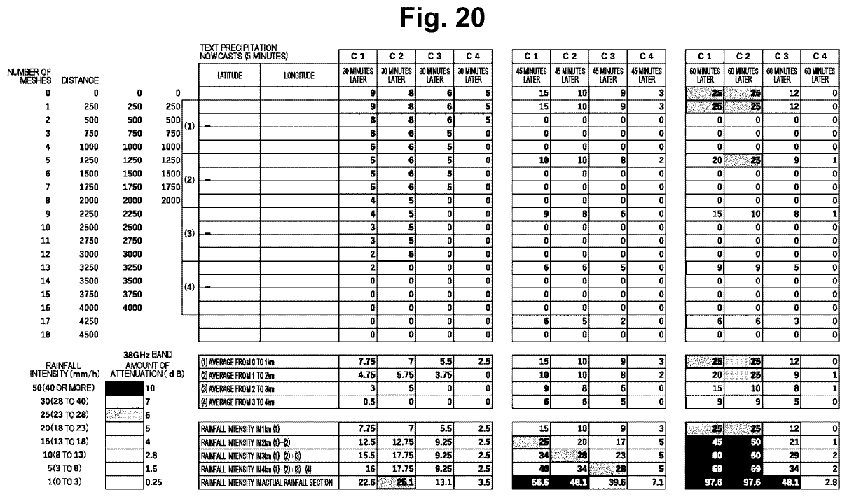

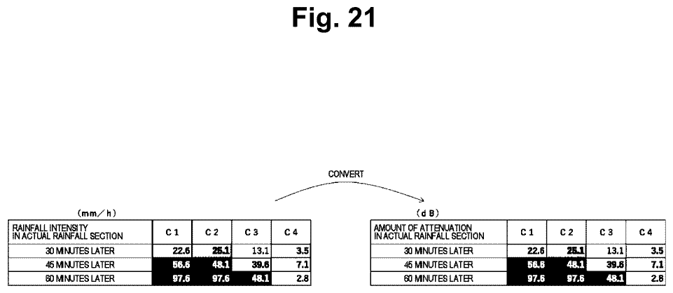

As shown in FIGS. 16 to 19, the wireless communication system extracts predicted values of the rainfall intensity (R) for each mesh of each cell 30 minutes later, 45 minutes later, and 60 minutes later as data of the actual rainfall section t minutes later. Further, the wireless communication system simultaneously extracts the predicted values of the rainfall intensity (1) to (4). For example, as shown in FIG. 20, the wireless communication system extracts the predicted values of the rainfall intensity of “(1)+(2)+(3)+(4) in 4 km” and the actual rainfall section. Here, for example, as shown in FIG. 21, the wireless communication system extracts only the predicted values of the rainfall intensity in the “actual rainfall section” in each cell 30 minutes later, 45 minutes later, and 60 minutes later.

In the processing in S410, the wireless communication system extracts the amount of attenuation (dt) by using the rainfall intensity (R) and FIG. 15. For example, the wireless communication system extracts the amount of rain attenuation in the 38 GHz band by using the predicted values of the rainfall intensity of “(1)+(2)+(3)+(4) in 4 km” in each cell and FIG. 15, thereby obtaining the result shown in FIG. 21.

Then, in order to transition to the next prediction target time, the wireless communication system sets t=t+15 (S412) and returns to the processing in S404.

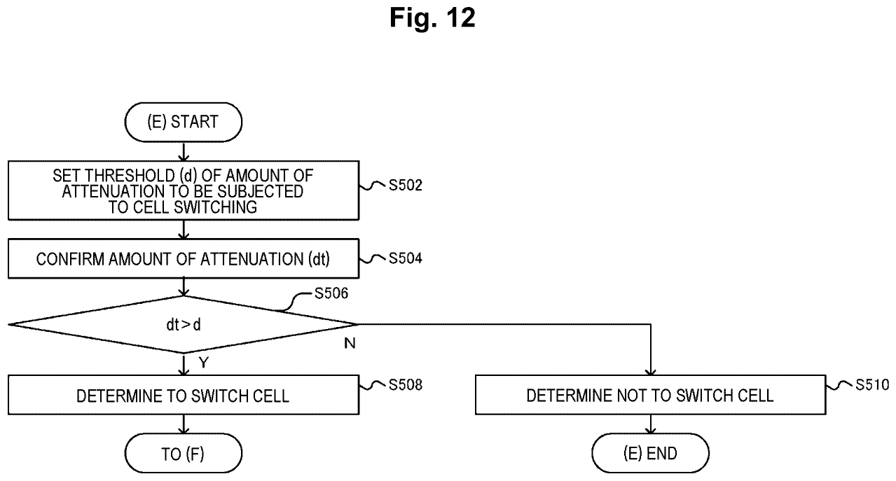

FIG. 12 is a flowchart showing details of the processing of (E) examining cell switching. First, the wireless communication system sets a threshold (d) of the amount of attenuation to be subjected to cell switching to, for example, 5 dB (d=5) (S502).

In the processing in S504, the wireless communication system extracts, from FIG. 21, the amount of attenuation (dt) in the actual rainfall section of the cell C1 the prediction target time (t minutes) later and confirms the amount of attenuation.

For example, the wireless communication system extracts the amount of attenuation dt in the actual rainfall section t=30 minutes later from FIG. 21 as the amount of attenuation dt=5 dB in the cell C1.

In the processing in S506, the wireless communication system determines whether or not the amount of attenuation (dt) in the actual rainfall section of the cell C1 the prediction target time (t minutes) later is larger than the threshold (d). When dt>d is satisfied (S506: Yes), the processing proceeds to the processing in S508. When dt>d is not satisfied (S506: No), the processing proceeds to the processing in S510.

In the processing in S508, the wireless communication system determines to switch the cell and transitions to the processing of (F) examining the cell switching destination.

In the processing in S510, the amount of attenuation t minutes later exceeds the threshold (d) for cell switching, and thus the wireless communication system determines not to switch the cell and ends the processing of (E) examining cell switching.

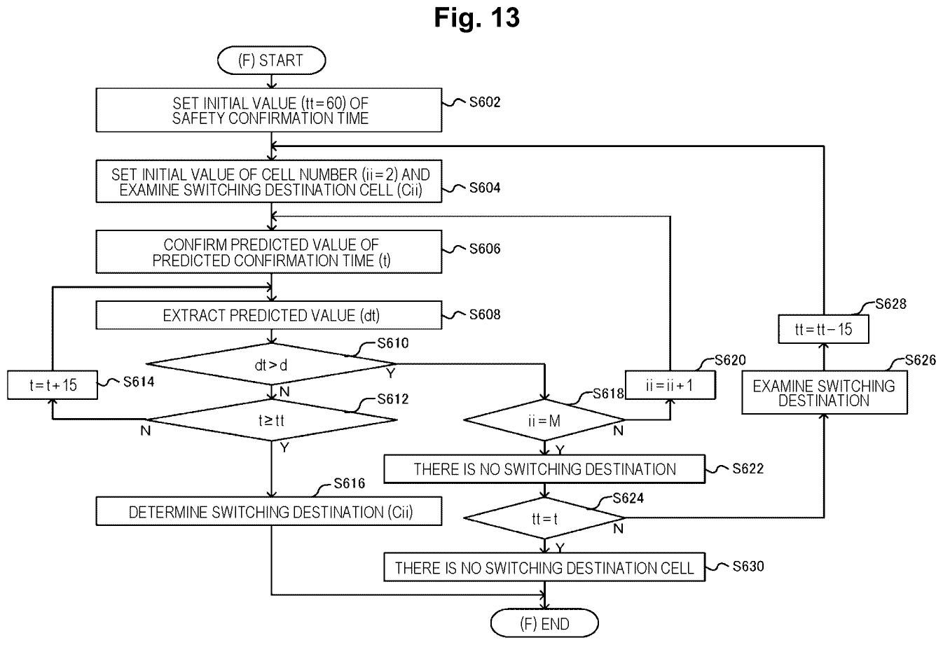

FIG. 13 is a flowchart showing details of the processing of (F) examining the cell switching destination. First, the wireless communication system sets a safety confirmation time to tt minutes later (initial value: tt=60) (S602).

Next, the wireless communication system starts examination of a switching destination cell Cii (initial value: ii=2: cell C2) (S604) and confirms a predicted value of a predicted confirmation time t minutes later (initial value: t=30:30 minutes later) (S606).

Next, the wireless communication system extracts the predicted value dt of the Ci cell t minutes later by using FIG. 21 (S608). At this time, the predicted value of the cell C2 30 minutes later is 4 dB.

In the processing in S610, the wireless communication system determines whether or not the predicted value dt is larger than the threshold d. When the predicted value dt is larger than the threshold d (S610: Yes), the processing proceeds to the processing in S618. When the predicted value dt is not larger than the threshold d (S610: No), the processing proceeds to the processing in S612. Here, d=5 dB holds, and thus dt=4 dB<d=5 dB holds.

In the processing in S612, the wireless communication system determines whether or not the predicted confirmation time t is equal to or longer than the safety confirmation time tt. When the predicted confirmation time t is equal to or longer than the safety confirmation time tt (S612: Yes), the processing proceeds to the processing in S616. When the predicted confirmation time t is not equal to or longer than the safety confirmation time tt (S612: No), the processing proceeds to the processing in S614.

In the processing in S614, in order to transition to the next predicted confirmation time, the wireless communication system sets t=t+15 and returns to the processing in S608.

In the processing in S616, the wireless communication system determines the cell Cii as the switching destination because the predicted value does not exceed the threshold d until the safety confirmation time tt minutes later.

In the processing in S618, the wireless communication system determines whether or not the cell is the final cell (ii=M). When ii=M is satisfied (S618: Yes), the processing proceeds to S622. When i=M is not satisfied (S618: No), the processing proceeds to S620.

In the processing in S620, because the cell is not the final cell, the wireless communication system sets ii=ii+1, and the processing proceeds to the processing in S606. For example, in a case where the cell C2 is not the final cell, the wireless communication system starts to examine the next cell C3.

In the processing in S622, the wireless communication system determines that there is no switching destination in which the predicted value does not exceed the threshold d until the safety confirmation time tt later, and the processing proceeds to the processing in S624.

In the processing in S624, the wireless communication system determines whether or not the safety confirmation time tt is the prediction target time t (tt=t). When tt=t is satisfied (S624: Yes), the processing proceeds to the processing in S630. When tt=t is not satisfied (S624: No), the processing proceeds to the processing in S626.

In the processing in S626, the wireless communication system changes the safety confirmation time tt (15 minutes before) and examines the switching destination that does not exceed the threshold d.

In the processing in S628, the wireless communication system sets tt=tt−15 and returns to the processing in S604.

In the processing in S630, the wireless communication system determines that there is no switching destination cell and ends the processing of (F) examining the cell switching destination.

For example, in the example of FIG. 21, the attenuation of 5 dB or more is expected 30 minutes or more later at the cell C1, and thus the wireless communication system examines switching to another point. For example, the wireless communication system switches to C4 less affected by rainfall (up to approximately 1.5 dB) 30 minutes later, 45 minutes later, and 60 minutes later.

As described above, in a case where the wireless communication system according to the embodiment determines that the feeder link of the relay station to which the service link is connected does not satisfy the predetermined communication quality, the wireless communication system controls the feeder link such that the feeder link satisfies the predetermined communication quality. Therefore, deterioration in the communication quality can be prevented even in a case where the entire area covered by one relay station moving in the sky in the NTN is affected by rainfall.

As described above, the wireless communication system according to the embodiment also has functions of transmitter power control (TCP) for amplifying transmission power in accordance with an amount of loss and AMC (adaptive modulation and coding) for adaptively controlling MCS (modulation and coding scheme) in accordance with the amount of loss to adjust a required carrier to noise and interference ratio (CNIR) by using an estimation result of the amount of propagation loss such as rain attenuation.

Some or all of the functions of the terminal 10, the ground station 20, the relay station 30, and the control station (not shown) shown in FIG. 2 may be configured by hardware such as a programmable logic device (PLD) or a field programmable gate array (FPGA) or may be configured as a program executed by a processor such as a CPU.

For example, the wireless communication system according to the present invention can be implemented by using a computer and a program, and the program may be recorded in a storage medium or provided through a network.

### REFERENCE SIGNS LIST

10 Terminal
20 Ground station
30 Relay station
40 Extraction unit
41 Section calculation unit
42 Loss amount calculation unit
43 Prediction unit
44 Determination unit
45 Control unit

1. A wireless communication method with an NTN, the wireless communication method comprising:
extracting rainfall data of each of places between a plurality of relay stations moving in the sky in the NTN and a plurality of ground stations placed on the ground in respective cells formed by the relay stations at predetermined time intervals from rainfall prediction of each predetermined region based on observation data of a weather radar;
predicting deterioration in communication of a feeder link of each of the plurality of relay stations caused by rainfall on the basis of the extracted rainfall data;
determining whether or not the feeder link of each of the plurality of relay stations satisfies a predetermined communication quality on the basis of the predicted deterioration in communication of each feeder link; and
in a case where it is determined that the feeder link of the relay station to which a service link is connected does not satisfy the predetermined communication quality, controlling the feeder link such that the feeder link satisfies the predetermined communication quality.

2. The wireless communication method according to claim 1, wherein
in controlling,
in a case where it is determined that the feeder link of the relay station to which the service link is connected does not satisfy the predetermined communication quality, the controlling is performed to switch a propagation path such that any of other relay stations whose feeder links are determined to satisfy the predetermined communication quality relays the feeder link of the relay station to any of the ground stations.

3. The wireless communication method according to claim 1, wherein
in controlling,
in a case where it is determined that the feeder link of the relay station to which the service link is connected does not satisfy the predetermined communication quality, the controlling is performed to increase transmission power of the relay station or to change a modulation method or code rate of the relay station.

4. The wireless communication method according to claim 1, further comprising:
calculating each rainfall section between the relay station and the ground station on the basis of the extracted rainfall data; and
calculating an amount of radio wave propagation loss caused by the calculated rainfall section, wherein
in predicting,
the deterioration in communication of the feeder link of each of the plurality of the relay stations caused by rainfall is predicted on the basis of each calculated amount of radio wave propagation loss.

5. A wireless communication system including an NTN, the wireless communication system comprising:
extraction circuitry configured to extract rainfall data of each of places between a plurality of relay stations moving in the sky in the NTN and a plurality of ground stations placed on the ground in respective cells formed by the relay stations at predetermined time intervals from rainfall prediction of each predetermined region based on observation data of a weather radar;
prediction circuitry configured to predict deterioration in communication of a feeder link of each of the plurality of relay stations caused by rainfall on the basis of the rainfall data extracted by the extraction circuitry;
determination circuitry configured to determine whether or not the feeder link of each of the plurality of relay stations satisfies a predetermined communication quality on the basis of the deterioration in communication of each feeder link predicted by the prediction circuitry; and
a controller that, in a case where the determination circuitry determine that the feeder link of the relay station to which a service link is connected does not satisfy the predetermined communication quality, control the feeder link such that the feeder link satisfies the predetermined communication quality.

6. The wireless communication system according to claim 5, wherein
in a case where the determination circuitry determine that the feeder link of the relay station to which the service link is connected does not satisfy the predetermined communication quality, the controller performs control to switch a propagation path such that any of other relay stations whose feeder links are determined by the determination circuitry to satisfy the predetermined communication quality relays the feeder link of the relay station to any of the ground stations.

7. The wireless communication system according to claim 5, wherein
in a case where the determination circuitry determine that the feeder link of the relay station to which the service link is connected does not satisfy the predetermined communication quality, the controller performs control to increase transmission power of the relay station or to change a modulation method or code rate of the relay station.

8. The wireless communication system according to claim 5, further comprising:
section calculation circuitry configured to calculate each rainfall section between the relay station and the ground station on the basis of the rainfall data extracted by the extraction circuitry; and
loss amount calculation circuitry configured to calculate an amount of radio wave propagation loss caused by the rainfall section calculated by the section calculation circuitry, wherein
the prediction circuitry predict the deterioration in communication of the feeder link of each of the plurality of the relay stations caused by rainfall on the basis of each amount of radio wave propagation loss calculated by the loss amount calculation circuitry.
